(19) United States
(12) Patent Application Publication
(10) Pub. No.: US 2011/0288850 A1
(43) Pub. Date: Nov. 24, 2011

(54) ELECTRONIC APPARATUS WITH MULTI-MODE INTERACTIVE OPERATION METHOD

(75) Inventors: Jia-Lin SHEN, Taoyuan Hsien (TW); Tien-Ming HSU, Taoyuan Hsien (TW); Rong HSU, Taoyuan Hsien (TW); Yu-Kai CHEN, Taoyuan Hsien (TW); Rong-Chang LIANG, Taoyuan Hsien (TW)

(73) Assignee: DELTA ELECTRONICS, INC., TAOYUAN HSIEN (TW)

(21) Appl. No.: 13/044,571

(22) Filed: Mar. 10, 2011

(30) Foreign Application Priority Data
May 21, 2010 (TW) 99116228

(51) Int. Cl. G06F 17/28; G06F 3/041; G06F 3/042; G10L 11/00

(52) U.S. Cl. 704/2; 704/275; 345/173; 345/175; 704/E11.001

(57) ABSTRACT

An electronic apparatus with a multi-mode interactive operation method is disclosed. The electronic apparatus includes a display unit, a selecting unit, a voice recognition unit and a control unit. The display unit displays a frame. The selecting unit selects an arbitrary area of the frame on the display unit. The voice recognition unit recognizes a voice signal as a control command. The control unit processes data according to the control command on the content of the arbitrary area selected. A multi-mode interactive operation method is disclosed herein as well.

### RELATED APPLICATIONS

This application claims priority to Taiwan Application Serial Number 99116228, filed May 21, 2010, which is herein incorporated by reference.

### BACKGROUND

1. Technical Field

The present disclosure relates to an electronic apparatus and the operation method of the same. More particularly, the present disclosure relates to an electronic apparatus with a multi-mode interactive operation method and the multi-mode interactive operation method of the same.

2. Description of Related Art

E-book is a new technology invented in recent years. Due to the high capacity of the e-book, the digitized documents, figures, books and music scores can be stored in the e-book or the peripheral storage device adaptable to the e-book. The display of the e-book can further display the content of the files such that the user can read books, search for data or receive multimedia information at any time without carrying many books.

Buttons or touch panels are the common tools used to operate the menu of the e-book device. In order to perform the desired function, the user has to gradually select the corresponding options of each level of the menu, which is time-consuming. Further, the reaction to the touch input of the touch panel of the e-book device is still not sensitive enough, causing the inconvenience of the user.

Consequently, a number of the modern technologies are proposed to address the above issues. A voice-recognition control method to operate an e-reader is disclosed in U.S. Pat. No. 2003/2016915. The method described in U.S. Pat. No. 7,107,533 is to make the e-book device generate a pattern output according to a pattern input and generate an audio output according to an audio input respectively to accomplish the multi-mode input/output method on the e-book device. The electronic apparatus provided in U.S. Pat. No. 6,438,523 can receive audio input in a first input mode and receive the hand-written or hand-drawn input in a second input mode respectively such that it is able to switch between the audio input mode and the hand-written/hard-drawn mode to control the electronic device. The hand-held device provided in U.S. Pat. No. 7,299,182 is able to generate audio output according to the text file stored within.

Though the technologies of touch input and audio input are used in the above disclosures, they are used separately. These technologies lack of the integration of touch and audio input technologies. If an integration of various kinds of input technologies is made to combine the advantages of these input technologies, the user does not have to worry about the complex input interface and can easily operate the electronic apparatus in an interactive and convenient way without constraint even if the user is not familiar with the electronic apparatus.

Accordingly, what is needed is an electronic apparatus with a multi-mode interactive operation method and the multi-mode interactive operation method of the same. The present disclosure addresses such a need.

### SUMMARY

An aspect of the present disclosure is to provide an electronic apparatus with a multi-mode interactive operation method. The electronic apparatus comprises a display unit, a selecting unit, a voice recognition unit and a control unit. The display unit displays a frame. The selecting unit selects an arbitrary area of the frame on the display unit. The voice recognition unit receives a voice signal and recognizes the voice signal as a control command. The control unit processes data according to the control command on a content of the arbitrary area selected.

Another aspect of the present disclosure is to provide an electronic apparatus with a multi-mode interactive operation method. The electronic apparatus comprises a display unit, a selecting unit, a pattern recognition unit and a control unit. The display unit displays a frame. The selecting unit selects an arbitrary area of the frame on the display unit. The pattern recognition unit receives a pattern and recognizes the pattern as a control command. The control unit processes data according to the control command on a content of the arbitrary area selected.

Yet another aspect of the present disclosure is to provide an electronic apparatus with a multi-mode interactive operation method. The electronic apparatus comprises a display unit, a selecting unit, an image recognition unit and a control unit. The display unit displays a frame. The selecting unit selects an arbitrary area of the frame on the display unit. The image recognition unit receives an image and recognizes the image as a control command. The control unit processes data according to the control command on a content of the arbitrary area selected.

Still another aspect of the present disclosure is to provide a multi-mode interactive operation method adapted in an electronic apparatus. The multi-mode interactive operation method comprises the following steps. A display unit displays a frame. A selection of an arbitrary area of the frame on the display unit is performed. An audio signal is received. The audio signal is recognized as a control command. Data is processed according to the control command on the content of the arbitrary area selected.

Further, another aspect of the present disclosure is to provide a multi-mode interactive operation method adapted in an electronic apparatus. The multi-mode interactive operation method comprises the following steps. A display unit displays a frame. A selection of an arbitrary area of the frame on the display unit is performed. A pattern is received. The pattern is recognized as a control command. Data is processed according to the control command on the content of the arbitrary area selected.

Another aspect of the present disclosure is to provide a multi-mode interactive operation method adapted in an electronic apparatus. The multi-mode interactive operation method comprises the following steps. A display unit displays a frame. A selection of an arbitrary area of the frame on the display unit is performed. An image is received. The image is recognized as a control command. Data is processed according to the control command on a content of the arbitrary area selected.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of an electronic apparatus of an embodiment of the present disclosure;

FIG. 2A is a top view of the electronic apparatus in FIG. 1;

FIG. 2B is a top view of the electronic apparatus in FIG. 1 in another embodiment of the present disclosure;

FIG. 2C is a diagram of the electronic apparatus in FIG. 1 displaying the search result in the database of the website Wikipedia;

FIG. 3 is a flow chart of a multi-mode interactive operation method in an embodiment of the present disclosure;

FIG. 4A is a block diagram of an electronic apparatus of another embodiment of the present disclosure;

FIG. 4B is a top view of the electronic apparatus in FIG. 4;

FIG. 5 is a flow chart of a multi-mode interactive operation method in an embodiment of the present disclosure;

FIG. 6A is a block diagram of an electronic apparatus of yet another embodiment of the present disclosure;

FIG. 6B is a top view of the electronic apparatus in FIG. 6; and

FIG. 7 is a flow chart of a multi-mode interactive operation method in an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

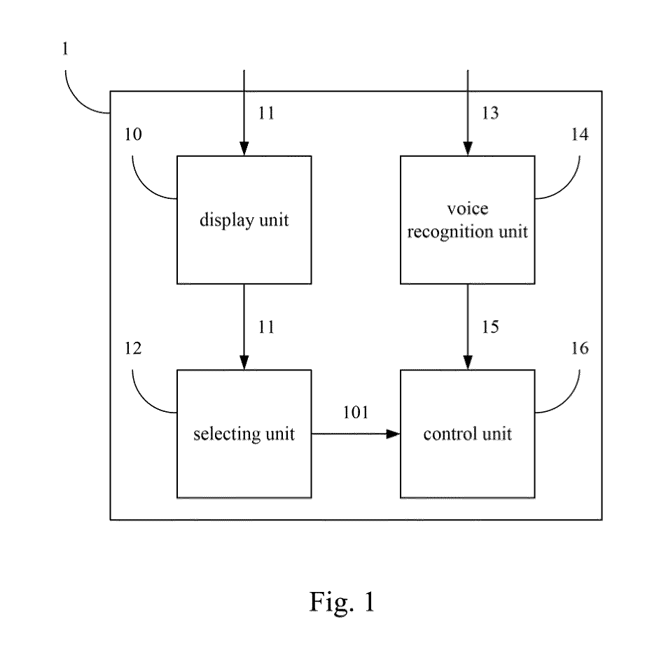

Please refer to FIG. 1. FIG. 1 is a block diagram of an electronic apparatus 1 of an embodiment of the present disclosure. The electronic apparatus 1 comprises a display unit 10, a selecting unit 12, a voice recognition unit 14 and a control unit 16.

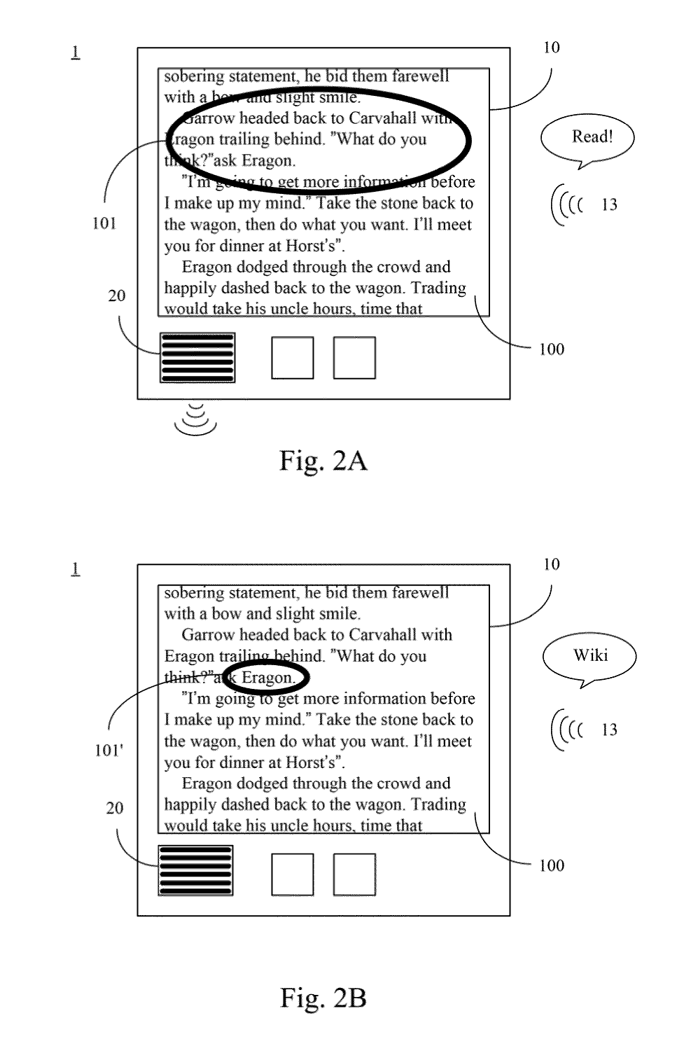

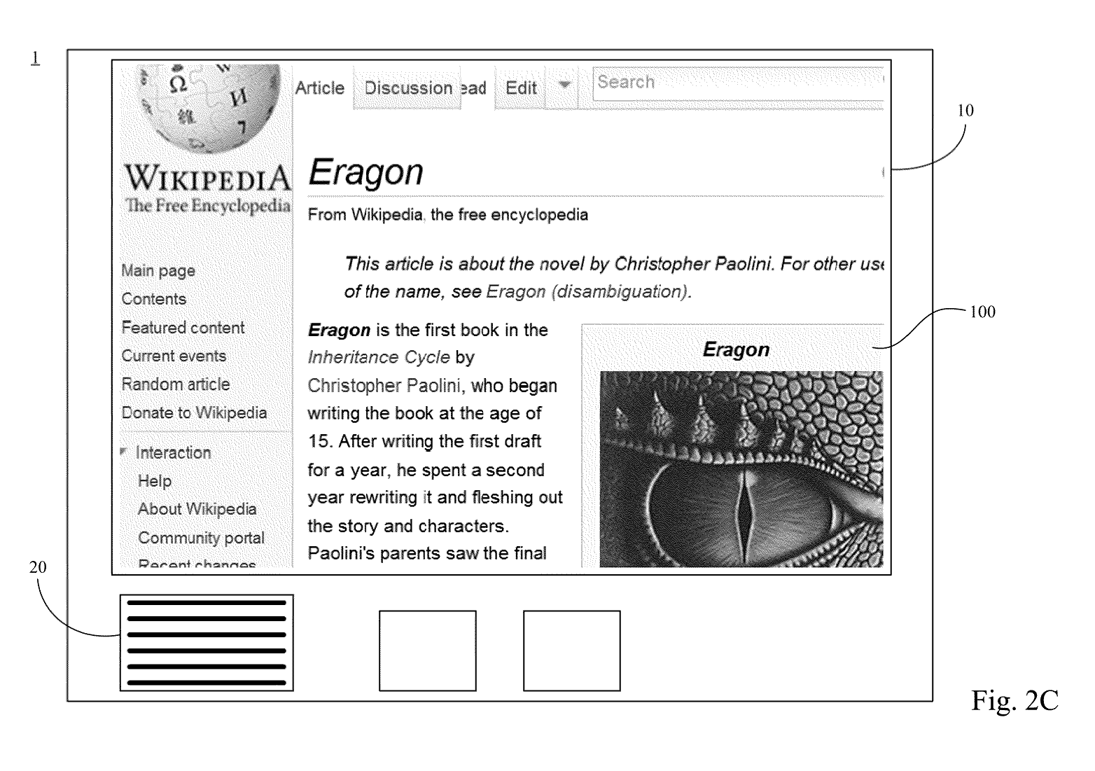

Please refer to FIG. 2A at the same time. FIG. 2A is a top view of the electronic apparatus 1. The electronic apparatus 1 can be an e-book, an e-reader, an e-paper or an electronic bulletin board in different embodiments. The display unit 10 displays a frame 100. The selecting unit 12 performs a selection of an arbitrary area of the frame 100 on the display unit 10. The display unit 10 can be a direct contact touch panel or a non-direct contact touch panel to sense a touch input signal 11. For example, the touch input signal 11 can be generated by a finger touch input or a stylus pen touch input. Therefore, the user can use a finger or a stylus pen (not shown) to perform the selection with a circle or with a frame. In the case of the non-direct contact touch, the user doesn't have to directly contact the display unit 10. In other words, when the user keeps a distance from the display unit 10 to make a movement, the display unit 10 is able to sense the movement and make the selection. It's noticed that the value of the distance described above depends on the sensitivity of the display unit 10 and is not limited by a specific value.

In the present embodiment, the selecting unit 12 selects the area 101 on the frame 100 of FIG. 2A according to the touch input signal 11, wherein the frame 100 shows a text file and the area 101 comprises a section of the article of the text file.

The voice recognition unit 14 receives a voice signal 13 and recognizes the voice signal 13 as a control command 15. The control unit 16 processes the data in the content of the area 101 selected previously according to the control command 15.

The control command 15 can be a pronouncing command, a reading command, a repeat-reading command, a translating command, an investigating is command, a music-playing command, a repeat-singing command, a zoom-in command or a zoom-out command. For example, the user can generate the voice signal 13 by saying “Read!” first. After the reception of the voice signal 13, the voice recognition unit 14 retrieves the control command 15 corresponding to the voice signal 13, which is “read” in the present embodiment, to accomplish the voice recognition process. Accordingly, the control unit 16 reads the section of the article within the area 101 through an audio amplification unit, such as the speaker 20 depicted in FIG. 2A.

Please refer to FIG. 2B. FIG. 2B is a top view of the electronic apparatus 1 in another embodiment of the present disclosure. In the present embodiment, the display unit 10 also displays the frame 100 as depicted in FIG. 2A. However, the selecting unit 12 select the area 101′ according to the touch input signal 11 in the present embodiment. Only the word ‘Eragon’ is presented in the area 101′. The user can generate the voice signal 13 by saying “Wiki”. After the reception of the voice signal 13, the voice recognition unit 14 finds the control command 15 corresponding to the voice signal 13 to accomplish the voice recognition process. Accordingly, the control unit 16 searches the word ‘Eragon’ in the database of the website Wikipedia according to the touch input signal 11 and show the search result on the display unit 10, as depicted in FIG. 2C. In other embodiments, the control command 15 can be defined to be corresponding to the database of the website Google or to the database of any online dictionary. Upon receiving the corresponding touch input signal 11, the control unit 16 searches the word in the database of Google or the online dictionary according to the control command 15 recognized by the voice recognition unit 14.

In yet another embodiment, for example, the content within the area is a is section of an article as follows: “A massive 7.0 magnitude earthquake has struck the Caribbean nation of Haiti. Haiti's ambassador to the U.S. states that the earthquake is a large-scale catastrophe.” When the user generates the voice signal 13 by saying “Repeat three times!”, the control unit 16 reads the section of the article within the area three times through the speaker 20 depicted in FIG. 2A.

If the selected area contains a title of a song, e.g. ‘Home’, the user can generate the voice signal 13 by saying “Sing!”. If different versions of the song are available in the electronic apparatus 1, the electronic apparatus 1 can show the options on the display unit 10 or inform the user through the speaker 20. After the user selects the desired version, the control unit 16 plays the song through the speaker 20. If the selected text is the lyrics of a song, the user can generate the voice signal 13 by saying “Repeat-singing” to make the control unit 16 plays the song with lyrics through the speaker 20. In still another embodiment, if the frame 100 displays a music score and the selected area 101 corresponds to a part of the music score, the user can generate the voice signal 13 by saying “Play!”. The control unit 16 then plays the part of the music score through the speaker 20.

In another embodiment, if the frame 100 displays an article or a graph, the user can generate the voice signal 13 by saying “Zoom in!” or “Zoom out!”. The selected section of the article or the selected part of the graph can be zoom-in or zoom-out such that the user can read the article or observe the graph clearly.

The electronic apparatus 1 with the multi-mode interactive operation method incorporates the touch input and the voice input such that the user is able to select a specific part of the article, a word, a title of the song or a graph by using the touch input and control the selected part of the file shown on the display unit 10 by using the voice input. The intuitive multi-mode interactive operation method avoids the time-consuming step-by-step selection of the menu adapted in the conventional electronic apparatus. Further, the output can be generated from the display unit 10, the audio amplification unit or other multimedia units of the electronic apparatus 1 depending on different situations. Accordingly, the electronic apparatus 1 can be adapted in devices such as e-readers, electronic dictionaries, language-learning devices, educational toys, reading machines and electronic musical score display devices to provide the user a more efficient learning experience. The electronic apparatus 1 can also be adapted in multimedia devices such as karaoke machines, game apparatuses, advertising devices, Set-top boxes, Kiosks, drama scripts and song scripts to make the user operate the multimedia devices rapidly without constraint.

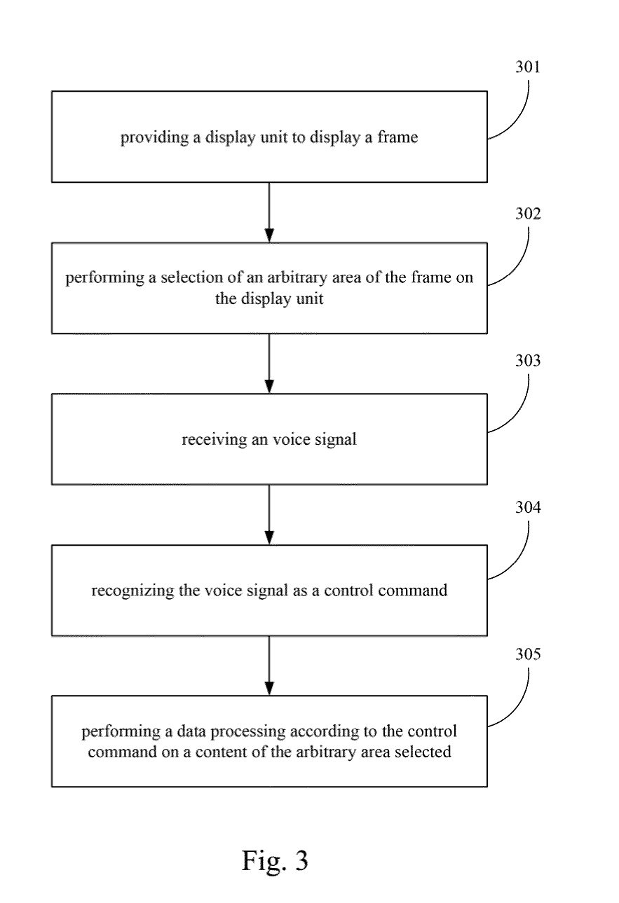

Please refer to FIG. 3. FIG. 3 is a flow chart of a multi-mode interactive operation method in an embodiment of the present disclosure. The multi-mode interactive operation method can be adapted in the electronic apparatus 1 depicted in FIG. 1. The multi-mode interactive operation method comprises the following steps. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

A display unit 10 displays a frame 100 in step 301. In step 302, a selection of an arbitrary area 101 of the frame 100 on the display unit 10 is performed by receiving a touch input signal 11 from the display unit 10. In step 303, a voice signal 13 is received. The voice signal 13 is recognized as a control command 15 in step 304. In step 305, Data is processed according to the control command 15 on a content of the arbitrary area 101 selected.

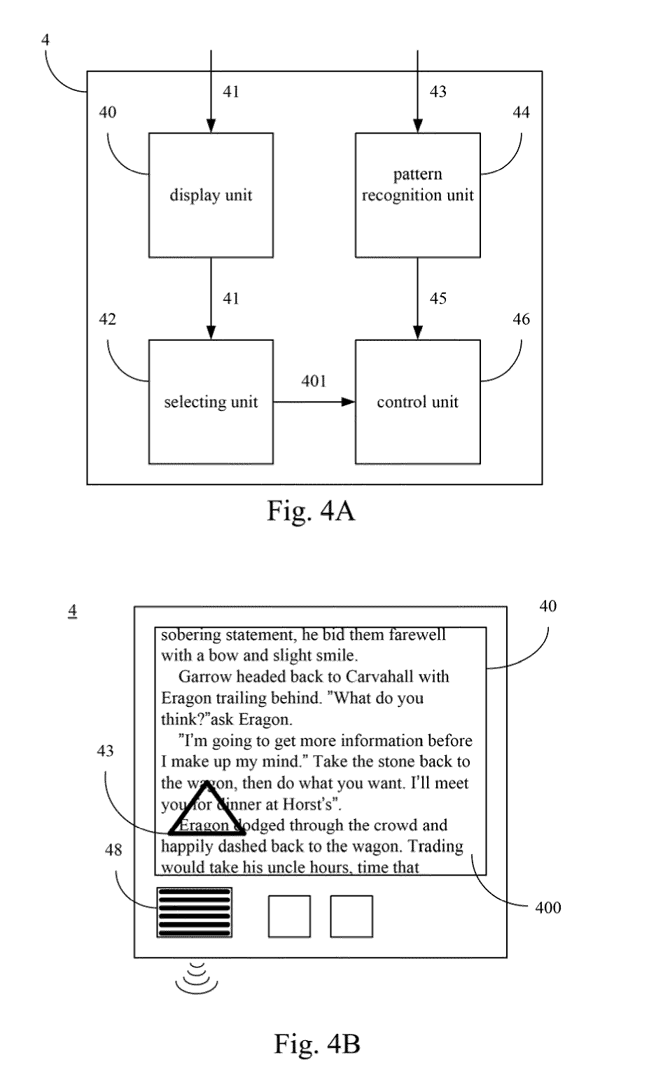

Please refer to FIG. 4A. FIG. 4A is a block diagram of an electronic apparatus 4 of another embodiment of the present disclosure. The electronic apparatus 4 comprises a display unit 40, a selecting unit 42, a pattern recognition unit 44 and a control unit 46.

The display unit 40, the selecting unit 42 and the control unit 46 is about the same as in the previous embodiment. Consequently, no further detail is described herein. The electronic apparatus 4 of the present embodiment makes use of the pattern recognition unit 44 to recognize a pattern drawn by a hand or by a stylus pen as a corresponding control command 45 such that the control unit 46 processes data on the file displayed on the display unit 40. Therefore, the electronic apparatus 4 incorporates the area selection and the pattern recognition to perform the data processing on the file shown on the display unit 40.

Please refer to FIG. 4B. FIG. 4B is a top view of the electronic apparatus 4 with a multi-mode interactive operation method in another embodiment of the present disclosure. For example, if the user selects the area 401 according to the input signal 41 from the display unit 40 and the selecting unit 42 in FIG. 4A, which is the word ‘Eragon’, the user can further draw a pattern on the frame 400 of the display unit 40 of the electronic apparatus 4 depicted in FIG. 4B, wherein the pattern is a triangular pattern 43 in the present embodiment. In the present embodiment, the control command 45 corresponding to the triangular pattern is a pronouncing command. Consequently, the control unit 46 pronounces the word ‘Eragon’ according to the control command 45 through the speaker 48. In other embodiments, the control command 45 can be a reading command, a repeat-reading command, a translating command, an investigating command, a music-playing command, a repeat-singing command, a zoom-in command or a zoom-out command as well. The commands can be defined to be corresponding to different patterns like a square, a circle or a trapezoid.

The electronic apparatus 4 with the multi-mode interactive operation method incorporates the touch input and the pattern input such that the user is able to select a specific part of the article, a word, a title of the song or a graph by using the touch input and control the file shown on the display unit 40 by using the pattern input. The intuitive multi-mode interactive operation method avoids the time-consuming step-by-step selection of the menu adapted in the conventional electronic apparatus. Further, the output can be generated from the display unit 40, the audio amplification unit or other multimedia units of the electronic apparatus 4 depending on different situations.

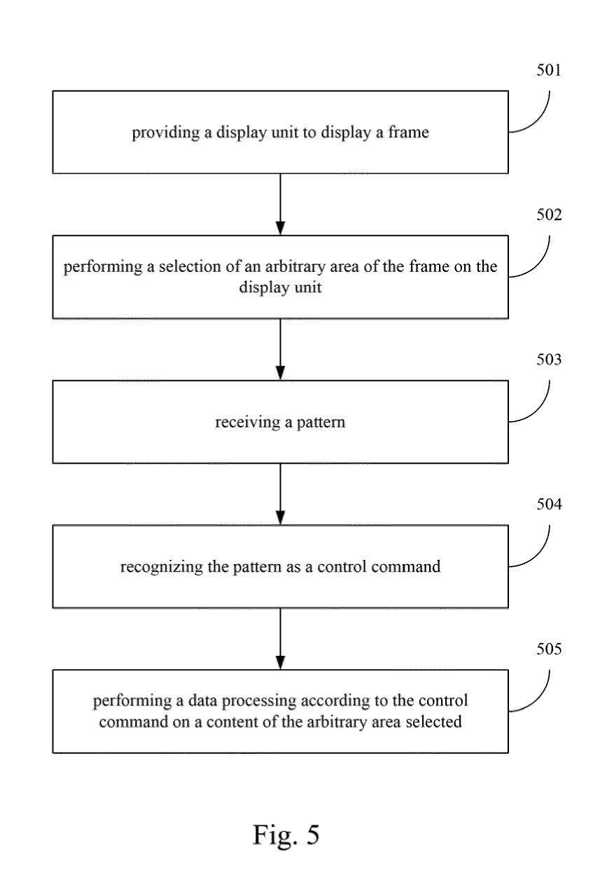

Please refer to FIG. 5. FIG. 5 is a flow chart of a multi-mode interactive operation method in an embodiment of the present disclosure. The multi-mode interactive operation method can be adapted in the electronic apparatus 4 depicted in FIG. 4A and FIG. 4B. The multi-mode interactive operation method comprises the following steps. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

A display unit 40 displays a frame 400 in step 501. In step 502, a selection of an arbitrary area 401 of the frame 400 on the display unit 40 is performed by receiving a touch input signal 41 from the display unit 40. In step 503, a pattern 43 is received. The pattern 43 is recognized as a control command 45 in step 504. In step 505, Data is processed according to the control command 45 on a content of the arbitrary area 401 selected.

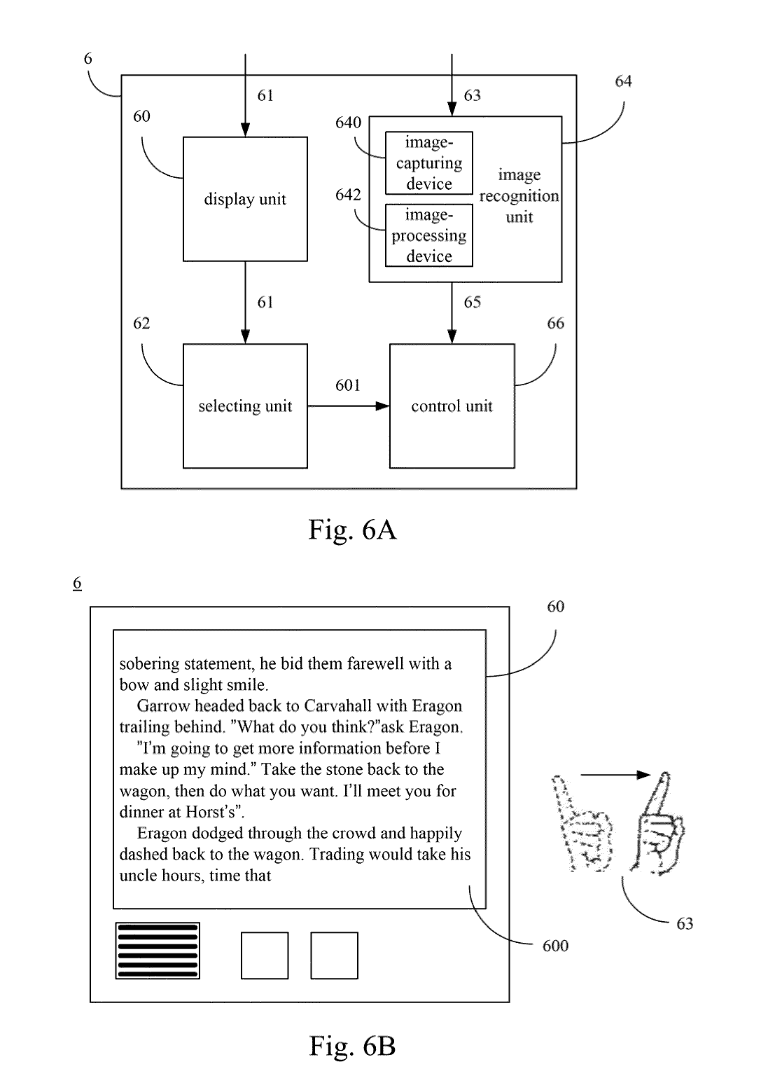

Please refer to FIG. 6A. FIG. 6A is a block diagram of an electronic apparatus 6 of yet another embodiment of the present disclosure. The electronic apparatus 6 comprises a display unit 60, a selecting unit 62, an image recognition unit 64 and a control unit 66.

The display unit 60, the selecting unit 62 and the control unit 66 is about the same as in the previous embodiments. Consequently, no further detail is described herein. The electronic apparatus 6 of the present embodiment makes use of the image recognition unit 64 to recognize an image input 63 as a corresponding control command 65 such that the control unit 66 processes data on the file displayed on the display unit 60. The image can be a motion image or a still image. The image recognition unit 64 comprises an image-capturing device 640 to retrieve the image input 63 and an image-processing device 642 to perform an image-recognition. The image-capturing device 640 is a charge-coupled device, a CMOS device or other kinds of device. Therefore, the electronic apparatus 6 incorporates the area selection and the image recognition to perform the data processing on the file shown on the display unit 60.

Please refer to FIG. 6B. FIG. 6B is a top view of the electronic apparatus 6 with a multi-mode interactive operation method in yet another embodiment of the present disclosure. For example, if the user selects the area 601 according to the input signal 61 from the display unit 60 and the selecting unit 62 in FIG. 6A, which is the word ‘Eragon’, the image recognition unit 64 can receive an image from the user, such as the image 63 of a moving gesture near the electronic apparatus 6 depicted in FIG. 6B In an embodiment, the control command 65 corresponding to the image 63 is a searching command. Consequently, the control unit 66 searches the word ‘Eragon’ in the database of Wikipedia according to the control command 65 and shows the result as depicted in FIG. 2C. In other embodiments, the control command 65 can be a pronouncing command, a reading command, a repeat-reading command, a translating command, an investigating command, a music-playing command, a repeat-singing command, a zoom-in command or a zoom-out command as well. The commands can be defined to be corresponding to the gesture or hand-written image input with different direction or movements such as left-right movement, circular movement and pointing/pushing movements.

The electronic apparatus 6 with the multi-mode interactive operation method incorporates the touch input and the image input such that the user is able to select a specific part of the article, a word, a title of the song or a graph by using the touch input and control the file shown on the display unit 60 by using the image input. The intuitive multi-mode interactive operation method avoids the time-consuming step-by-step selection of the menu adapted in the conventional electronic apparatus. Further, the output can be generated from the display unit 60, the audio amplification unit or other multimedia units of the electronic apparatus 6 depending on different situations.

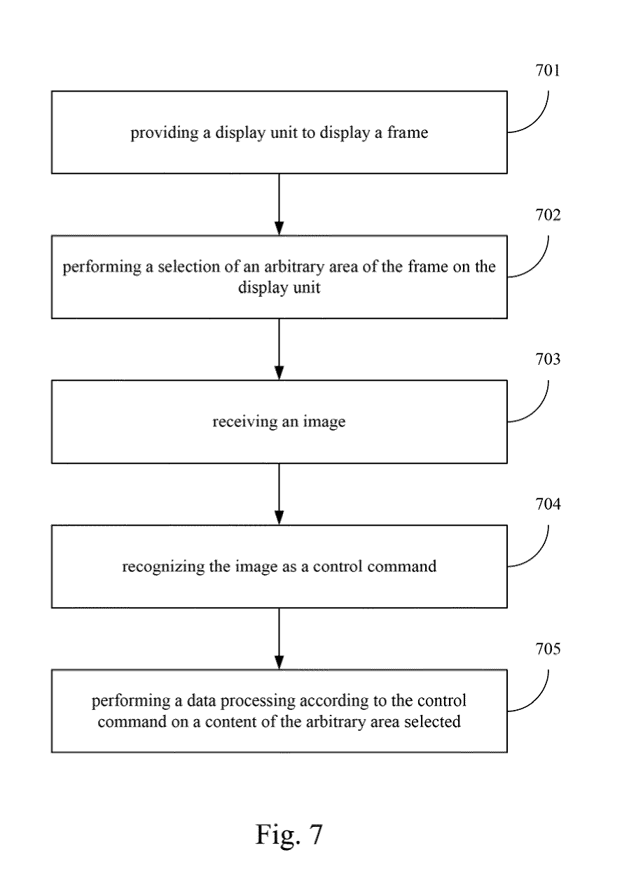

Please refer to FIG. 7. FIG. 7 is a flow chart of a multi-mode interactive operation method in an embodiment of the present disclosure. The multi-mode interactive operation method can be adapted in the electronic apparatus 6 depicted in FIG. 6A and FIG. 6B. The multi-mode interactive operation method comprises the following steps. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

A display unit 60 displays a frame 600 in step 701. In step 702, a selection of an arbitrary area 601 of the frame 600 on the display unit 60 is performed by receiving a touch input signal 61 from the display unit 60. In step 703, an image 63 is received. The image 63 is recognized as a control command 65 in step 704. In step 705, Data is processed according to the control command 65 on a content of the arbitrary area 601 selected.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An electronic apparatus with a multi-mode interactive operation method, comprising:
a display unit to display a frame;
a selecting unit to perform a selection of an arbitrary area of the frame on the display unit;
a voice recognition unit to receive a voice signal and recognize the voice signal as a control command; and
a control unit to perform a data processing according to the control command on a content of the arbitrary area selected.

2. The electronic apparatus of claim 1, wherein the display unit is a direct contact touch panel or a non-direct contact touch panel.

3. The electronic apparatus of claim 2, wherein the selection is performed by a finger touch input, a stylus pen touch input, a mouse input or a gesture input.

4. The electronic apparatus of claim 1, wherein the content of the arbitrary area comprises at least one word, at least one figure or at least one music score.

5. The electronic apparatus of claim 1, wherein the control command is a pronouncing command, a reading command, a repeat-reading command, a translating command, an investigating command, a music-playing command, a repeat-singing command, a zoom-in command or a zoom-out command.

6. The electronic apparatus of claim 1, wherein the electronic apparatus is an e-book, an e-reader, an e-paper or an electronic bulletin board.

7. An electronic apparatus with a multi-mode interactive operation method, comprising:
a display unit to display a frame;
a selecting unit to perform a selection of an arbitrary area of the frame on the display unit;
a pattern recognition unit to receive a pattern and recognize the pattern as a control command; and
a control unit to perform a data processing according to the control is command on a content of the arbitrary area selected.

8. The electronic apparatus of claim 7, wherein the display unit is a direct contact touch panel or a non-direct contact touch panel.

9. The electronic apparatus of claim 8, wherein the selection is performed by a finger touch input, a stylus pen touch input, a mouse input or a gesture input.

10. The electronic apparatus of claim 7, wherein the content of the arbitrary area comprises at least one word, at least one figure or at least one music score.

11. The electronic apparatus of claim 7, wherein the control command is a pronouncing command, a reading command, a repeat-reading command, a translating command, an investigating command, a music-playing command, a repeat-singing command, a zoom-in command or a zoom-out command.

12. The electronic apparatus of claim 7, wherein the electronic apparatus is an e-book, an e-reader, an e-paper or an electronic bulletin board.

13. An electronic apparatus with a multi-mode interactive operation method, comprising:
a display unit to display a frame;
a selecting unit to perform a selection of an arbitrary area of the frame on the display unit;
an image recognition unit to receive an image to recognize the image as a control command; and
a control unit to perform a data processing according to the control command on a content of the arbitrary area selected.

14. The electronic apparatus of claim 13, wherein the display unit is a direct contact touch panel or a non-direct contact touch panel.

15. The electronic apparatus of claim 14, wherein the selection is performed by a finger touch input, a stylus pen touch input, a mouse input or a gesture input.

16. The electronic apparatus of claim 13, wherein the content of the arbitrary area comprises at least one word, at least one figure or at least one music score.

17. The electronic apparatus of claim 13, wherein the control command is a pronouncing command, a reading command, a repeat-reading command, a translating command, an investigating command, a music-playing command, a repeat-singing command, a zoom-in command or a zoom-out command.

18. The electronic apparatus of claim 13, wherein the electronic is apparatus is an e-book, an e-reader, an e-paper or an electronic bulletin board.

19. The electronic apparatus of claim 13, wherein the image recognition unit comprises an image-capturing device to retrieve the image and an image-processing device to perform an image-recognition.

20. The electronic apparatus of claim 19, wherein the image-capturing device is a charge-coupled device, a CMOS device or other kinds of device.

21. The electronic apparatus of claim 13, wherein the image is a still image or a motion image.

22. A multi-mode interactive operation method adapted in an electronic apparatus, comprising the steps of:
providing a display unit to display a frame;
performing a selection of an arbitrary area of the frame on the display unit;
receiving a voice signal;
recognizing the voice signal as a control command; and
performing a data processing according to the control command on a to content of the arbitrary area selected.

23. The multi-mode interactive operation method of claim 22, wherein the selection is performed by a finger touch input, a stylus pen touch input, a mouse input or a gesture input.

24. The multi-mode interactive operation method of claim 22, wherein the content of the arbitrary area comprises at least one word, at least one figure or at least one music score.

25. The multi-mode interactive operation method of claim 22, wherein the control command is a pronouncing command, a reading command, a repeat-reading command, a translating command, an investigating command, a music-playing command, a repeat-singing command, a zoom-in command or a zoom-out command.

26. A multi-mode interactive operation method adapted in an electronic apparatus, comprising the steps of:
providing a display unit to display a frame;
performing a selection of an arbitrary area of the frame on the display unit;
receiving a pattern;
recognizing the pattern as a control command; and
performing a data processing according to the control command on a content of the arbitrary area selected.

27. The multi-mode interactive operation method of claim 26, wherein the selection is performed by a finger touch input, a stylus pen touch input, a mouse input or a gesture input.

28. The multi-mode interactive operation method of claim 26, wherein the content of the arbitrary area comprises at least one word, at least one figure or at least one music score.

29. The multi-mode interactive operation method of claim 26, wherein the control command is a pronouncing command, a reading command, a repeat-reading command, a translating command, an investigating command, a music-playing command, a repeat-singing command, a zoom-in command or a zoom-out command.

30. The multi-mode interactive operation method of claim 26, wherein the pattern is received according to a direct contact touch input or a non-direct contact touch input.

31. A multi-mode interactive operation method adapted in an electronic apparatus, comprising the steps of:
providing a display unit to display a frame;
performing a selection of an arbitrary area of the frame on the display unit;
receiving an image;
recognizing the image as a control command; and
performing a data processing according to the control command on a content of the arbitrary area selected.

32. The multi-mode interactive operation method of claim 31, wherein the selection is performed by a finger touch input, a stylus pen touch input, a mouse input or a gesture input.

33. The multi-mode interactive operation method of claim 31, wherein the content of the arbitrary area comprises at least one word, at least one figure or at least one music score.

34. The multi-mode interactive operation method of claim 31, wherein the control command is a pronouncing command, a reading command, a repeat-reading command, a translating command, an investigating command, a music-playing command, a repeat-singing command, a zoom-in command or a zoom-out command.

35. The multi-mode interactive operation method of claim 31, wherein the image is received according to a charge-coupled device, a CMOS device or other kinds of device.

36. The multi-mode interactive operation method of claim 31, herein the image is a still image or a motion image.
